(19) United States
(12) Patent Application Publication
(10) Pub. No.: US 2011/0045378 A1
(43) Pub. Date: Feb. 24, 2011

(54) FUEL CELL

(75) Inventors: Tomio Miyazaki, Wako-shi (JP); Takeo Ebina, Sendai-shi (JP); Fujio Mizukami, Ushiku-shi (JP)

Correspondence Address: NELSON MULLINS RILEY & SCARBOROUGH LLP;FLOOR 30, SUITE 3000, ONE POST OFFICE SQUARE, BOSTON, MA, 02109, US

(73) Assignee: HONDA MOTOR CO., LTD., Tokyo (JP)

(21) Appl. No.: 12/863,344

(22) PCT Filed: Jan. 16, 2009
(86) PCT No.: PCT/JP2009/050521

§ 371 Date: Sep. 30, 2010

(30) Foreign Application Priority Data
Jan. 18, 2008 (JP) 2008-009101

(51) Int. Cl. H01M 8/04; H01M 8/24

(52) U.S. Cl. 429/457

(57) ABSTRACT

A separator includes: a sandwiching unit which sandwiches an electrolyte/electrode assembly and has a fuel gas channel and an oxidizing gas channel which are arranged separately; a fuel gas supply unit having a fuel gas supply communication hole formed in the layering direction for supplying the fuel gas into the fuel gas channel; and a seal member arranged at an outer periphery of the fuel gas supply communication hole. The seal member has a clay film formed from a clay mineral and an organic polymer.

### TECHNICAL FIELD

The present invention relates to a fuel cell formed by sandwiching an electrolyte electrode assembly between separators. The electrolyte electrode assembly includes an anode, a cathode, and a solid oxide electrolyte interposed between the anode and the cathode.

### BACKGROUND ART

Typically, a solid oxide fuel cell (SOFC) employs an electrolyte of ion-conductive solid oxide such as stabilized zirconia. The electrolyte is interposed between an anode and a cathode to form an electrolyte electrode assembly, for example, a membrane electrode assembly (MEA). The electrolyte electrode assembly is interposed between separators (bipolar plates). In use, normally, predetermined numbers of the electrolyte electrode assemblies and the separators are stacked together to form a fuel cell stack.

In the fuel cell of this type, seals for suitably preventing leakage of a fuel gas supplied to the anode and an oxygen-containing gas supplied to the cathode need to be provided. For this purpose, various types of seal materials having various functions have been adopted selectively.

The seal materials are classified, e.g., into compression type (adhesion by compression type) seal material and liquid type seal material depending on the form of the seal material. The compression type seal material achieves the desired sealing performance mainly based on the restoring force in opposition to compression due to a tightening force. For example, a metal gasket or ceramic material (mica) can be used as the compression type seal material.

In the case of using this compression type seal material for the separators to improve the sealing performance, it is required to increase the tightening force applied to the separators in the stacking direction. Therefore, due to the excessive load applied to the separators and the MEAS, the separators may be deformed, and the MEAS may be damaged undesirably.

In contrast, the liquid type seal material achieves the desired sealing performance based on the adhesive property of the seal material. For example, glass seal material has this adhesive property. When the glass is melted, the glass seal material adheres to the separators to achieve the desired sealing performance.

In this regard, in particular, in the SOFC, since the temperature range where the power generation can be performed is significantly high, seal material that has the desired adhesive property at high temperature is required. However, though the glass seal material can adhere to the separators at high temperature, it is expanded or contracted significantly in comparison with the separators. Therefore, if the temperature is changed repeatedly by starting and stopping operation, the glass seal material is degraded rapidly.

In an attempt to address the problem, seal material for a solid oxide fuel cell operated at low temperature disclosed in Japanese Laid-Open Patent Publication No. 2004-039573 comprises a glass having a thermal expansion coefficient of (8.0 to 14.0)×10⁻⁶ K⁻¹, a softening point of 500° C. to 1200° C., and a connecting temperature of 750° C. to 1200° C. or a glass made by mixing this glass with a ceramic powder or a metal powder.

Further, a seal material for a solid oxide fuel cell disclosed in Japanese Laid-Open Patent Publication No. 2007-149430 comprises a mixed powder of a glass powder containing silicon as a constituent element, a magnesium oxide powder, and a magnesium silicate powder.

Further, in a gas sealing structure for a solid oxide fuel cell disclosed in Japanese Laid-Open Patent Publication No. 10-199555, unit cells and separators are stacked alternately to form the solid oxide fuel cell. The unit cell is formed by providing a fuel electrode on one surface of a solid electrolyte plate, and providing an air electrode on the other surface of the solid electrolyte plate. A ceramic fiber that is a little thicker than the solid electrolyte plate is formed around the outer edge of the solid electrolyte plate, and nickel foils are provided on the upper and lower surfaces of the ceramic fiber between the solid electrolyte plate and the separator such that the nickel foils are tightened between the separators and the ceramic fiber.

Further, in a solid oxide fuel cell disclosed in Japanese Laid-Open Patent Publication No. 2002-141083, a fuel electrode seal member interposed between a solid electrolyte layer and a fuel electrode separator blocks off the external air from a fuel supply/discharge passage, an air electrode seal member interposed between a solid electrolyte layer and an air electrode separator blocks off the external air from an air supply/discharge passage, and fuel electrode seal material and air electrode seal material are provided by applying a pair of viscous glass bodies composed of a mixture of glass material and diluent material on both surfaces of a seal body of alloy.

Further, in a cell plate used in a solid oxide fuel cell disclosed in Japanese Laid-Open Patent Publication No. 2007-115481, a cell support for supporting a solid oxide fuel cell and separating a fuel gas from the air, and a joint for adhering the solid oxide fuel cell to the cell support are provided.

The cell support comprises a metal ring, and a protective film layer formed by covering the surface of the metal ring with glass. The joint comprises a first glass layer adhered on an electrolyte layer, and a second glass layer which is disposed between the protective film layer and the first glass layer to join the protective film layer and the first glass layer.

However, in Japanese Laid-Open Patent Publication No. 2004-039573, though the glass seal material is softened to achieve the desired sealing performance, since a load in the stacking direction of the separators is applied, the softened glass seal material tends to be dispersed, and the durability is poor.

Further, in Japanese Laid-Open Patent Publication No. 2007-149430, since the chief component of the seal material is glass, due to heat expansion/compression or the load in the stacking direction, the durability is poor.

Further, in Japanese Laid-Open Patent Publication No. 10-199555, since the load in the stacking direction of the separators is applied to maintain the desired gas sealing performance, the gas sealing material and the nickel foils tend to be degraded easily.

Further, in Japanese Laid-Open Patent Publication No. 2002-141083, the seal body of alloy and viscous glass body are combined, and a relatively large load is applied between the separators to improve the gas sealing performance. Therefore, the viscous glass body tends to be dispersed, and degraded easily.

In Japanese Laid-Open Patent Publication No. 2007-115481, though the cell support and the joint are provided for maintaining the gas sealing performance, when the load in the stacking direction is applied, the glass layer tends to be degraded easily.

### DISCLOSURE OF INVENTION

The present invention has been made to solve the problems of this type, and an object of the present invention is to provide a fuel cell which makes it possible to suitably maintain the desired gas sealing performance for preventing leakage of a fuel gas and an oxygen-containing gas, reduce a load in a stacking direction, and maintain the desired sealing performance over a long period of time.

The present invention relates to a fuel cell formed by stacking an electrolyte electrode assembly between separators. The electrolyte electrode assembly includes an anode, a cathode, and a solid oxide electrolyte interposed between the anode and the cathode.

The separators have a fuel gas supply section for supplying a fuel gas to the anode or an oxygen-containing gas supply section for supplying an oxygen-containing gas to the cathode. A seal member for preventing leakage of the fuel gas or the oxygen-containing gas is provided on at least the fuel gas supply section or the oxygen-containing gas supply section. The seal member has a clay membrane made of a composite material of clay mineral and organic polymer for adhesion to the separators, the clay membrane having gas seal properties.

The seal material of the fuel cell is required to function as a gas barrier to maintain the hermetical state for preventing leakage of gases, mixture of gases, or mixture of the gases and exhaust gas. Further, the seal material is required to have the heat resistance to prevent degradation due to continuous use in power generation, and flexibility to improve the sealing performance while reducing the load in the stacking direction. In particular, in the case of SOFC, the sealing performance to prevent mixture of the fuel gas or the oxygen-containing gas with the exhaust gas is required. Further, since the SOFC is operated at high temperature of 800° C. to 1000° C., the sealing material needs to have high heat resistance.

In the present invention, the seal member having a clay membrane made of composite material of clay mineral and organic polymer is used. Therefore, it is possible to maintain the high sealing performance and the high heat resistance required for use as the seal material for the SOFC, and the sealing performance when the load is small.

That is, since the seal member has a clay membrane made of composite material of clay mineral and organic polymer, the seal member has the properties of both of the compression type seal member and the adhesion type seal member. Thus, the seal member has the high gas sealing performance. The seal member chiefly containing the clay mineral has the desired heat resistance and insulating properties. Further, the seal member is flexible. Therefore, the seal member can tightly adhere to the seal surface with a small load in comparison with the normal compression type seal member, and the load in the stacking direction can be reduced significantly.

Further, at the time of raising the temperature of the SOFC to a high operating temperature for power generation, the seal member tightly and reliably contacts the separator. Thus, further improvement in the gas sealing performance is achieved.

### BRIEF DESCRIPTION OF DRAWINGS

FIG. 1 is a perspective view schematically showing a fuel cell stack formed by stacking a plurality of fuel cells according to a first embodiment of the present invention.

FIG. 2 is an exploded perspective view showing the fuel cell.

FIG. 3 is a partial exploded perspective view showing gas flows in the fuel cell.

FIG. 4 is a cross sectional view schematically showing operation of the fuel cell.

FIG. 5 is a perspective view schematically showing a fuel cell stack formed by stacking fuel cells according to a second embodiment of the present invention.

FIG. 6 is an exploded perspective view showing the fuel cell.

FIG. 7 is a partial exploded perspective view showing gas flows in the fuel cell.

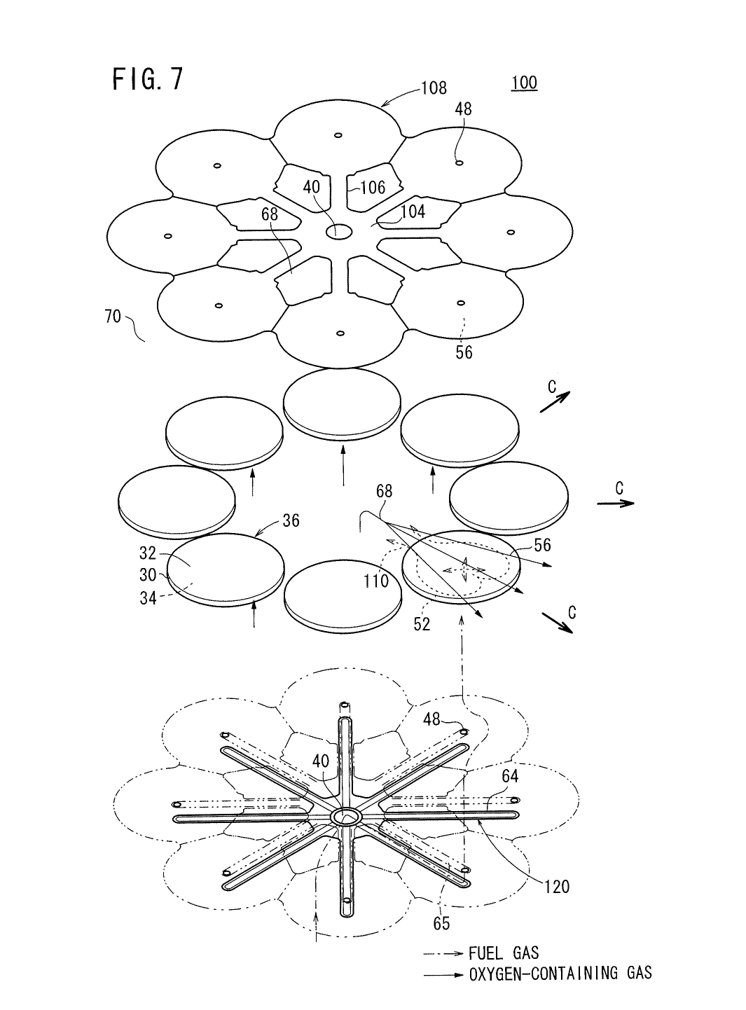

FIG. 8 is a cross sectional view schematically showing operation of the fuel cell.

FIG. 9 is a perspective view schematically showing a fuel cell stack formed by stacking a plurality of fuel cells according to a third embodiment of the present invention.

FIG. 10 is an exploded perspective view showing the fuel cell.

FIG. 11 is a partial exploded perspective view showing gas flows in the fuel cell.

FIG. 12 is a cross sectional view schematically showing operation of the fuel cell.

FIG. 13 is an exploded perspective view showing a fuel cell according to a fourth embodiment of the present invention.

FIG. 14 is a partial exploded perspective view showing gas flows in the fuel cell.

FIG. 15 is a cross sectional view schematically showing operation of the fuel cell.

FIG. 16 is an exploded perspective view showing a fuel cell according to a fifth embodiment of the present invention.

FIG. 17 is a cross sectional view showing a fuel cell according to a sixth embodiment of the present invention.

FIG. 18 is a plan view showing a separator of the fuel cell.

FIG. 19 is a cross sectional view showing a fuel cell according to a seventh embodiment of the present invention.

FIG. 20 is a cross sectional view showing a fuel cell according to an eighth embodiment of the present invention.

FIG. 21 is a cross sectional view showing a fuel cell according to a ninth embodiment of the present invention.

### BEST MODE FOR CARRYING OUT THE INVENTION

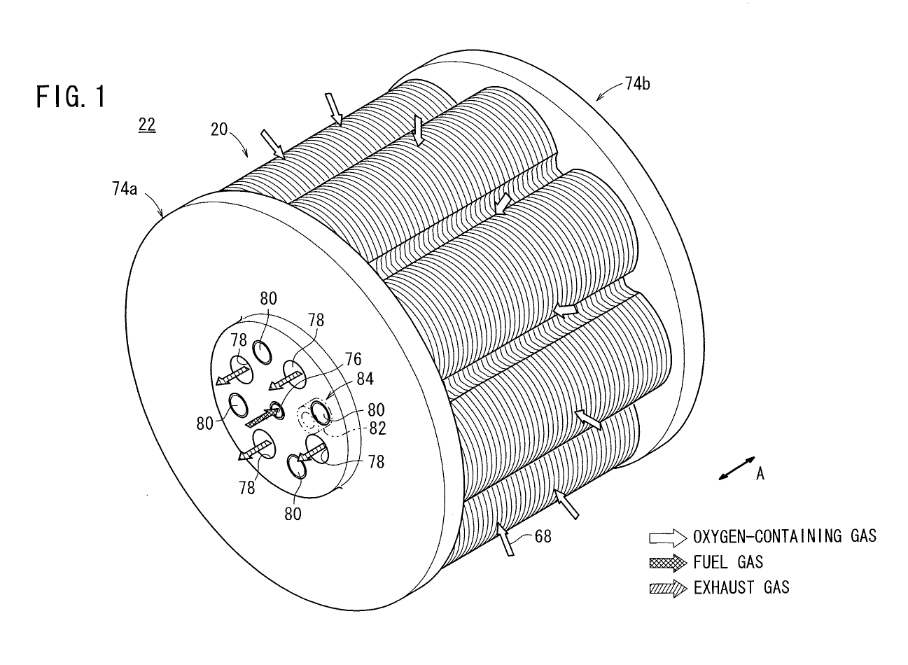

FIG. 1 is a perspective view schematically showing a fuel cell stack 22 formed by stacking fuel cells 20 according to a first embodiment of the present invention in a direction indicated by an arrow A.

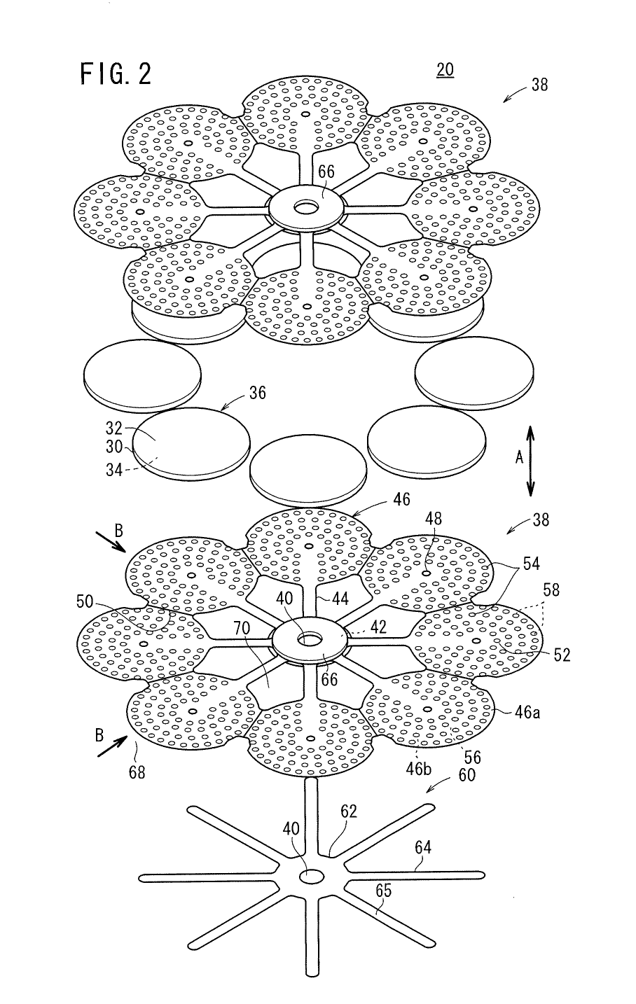

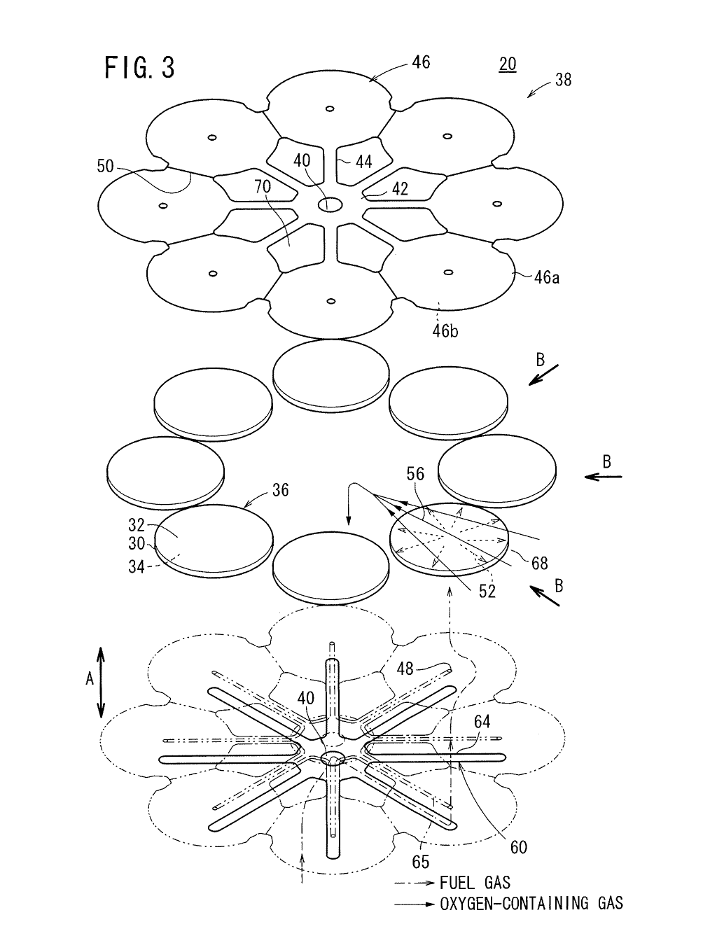

The fuel cell 20 is a solid oxide fuel cell used in various applications, including stationary and mobile applications. For example, the fuel cell 20 is mounted on a vehicle. As shown in FIGS. 2 and 3, the fuel cell 20 includes electrolyte electrode assemblies 36. Each of the electrolyte electrode assemblies 36 includes a cathode 32, an anode 34, and an electrolyte (electrolyte plate) 30 interposed between the cathode 32 and the anode 34. For example, the electrolyte 30 is made of ion-conductive solid oxide such as stabilized zirconia. Each of the electrolyte electrode assemblies 36 has a circular disk shape. The electrolyte electrode assemblies 36 are sandwiched between separators 38.

The separator 38 is a metal plate made of Fe alloy (SUS) or the like. As shown in FIG. 2, a fuel gas supply section 42 is provided at the center of the separators 38, and a fuel gas supply passage (reactant gas supply passage) 40 extends through the fuel gas supply section 42 for supplying a fuel gas in the stacking direction indicated by the arrow A. Eight bridges 44 extend radially outwardly from the fuel gas supply section 42 such that the bridges 44 are spaced at equal intervals (angles). Each of the bridges 44 is integral with a sandwiching section 46 having a circular disk shape.

Each of the sandwiching sections 46 has substantially the same dimensions as the electrolyte electrode assembly 36. A fuel gas inlet 48 for supplying the fuel gas is formed, for instance, at the center of the sandwiching section 46, or at an upstream position deviated from the center of the sandwiching section 46 in the flow direction of the oxygen-containing gas. The adjacent sandwiching sections 46 are separated from each other by a slit 50.

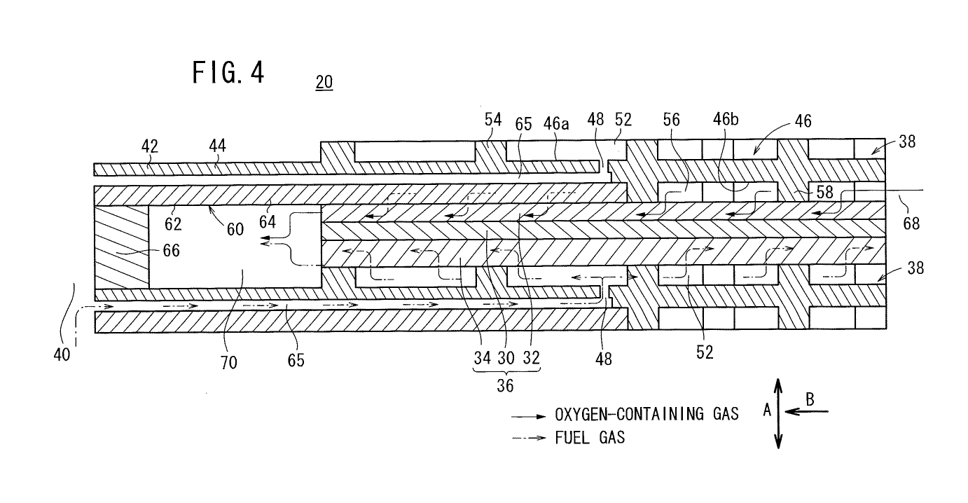

As shown in FIGS. 2 and 4, each of the sandwiching sections 46 has a plurality of projections 54 on its surface 46a which contacts the anode 34. The projections 54 form a fuel gas channel 52 for supplying the fuel gas along an electrode surface of the anode 34. Further, each of the sandwiching sections 46 has a plurality of projections 58 on its surface 46b which contacts the cathode 32. The projections 58 form an oxygen-containing gas channel 56 for supplying the oxygen-containing gas along an electrode surface of the cathode 32.

A channel lid member 60 is fixed to a surface of the separator 38 facing the cathode 32, e.g., by brazing or laser welding. The channel lid member 60 has a flat shape. A fuel gas supply section 62 is provided at the center of the channel lid member 60. The fuel gas supply passage 40 extends through the fuel gas supply section 62. Eight bridges 64 extend radially from the fuel gas supply section 62. Each of the bridges 64 is fixed to the separator 38 over the surfaces of the bridge 44 to the sandwiching section 46 to cover the fuel gas inlet 48. Thus, a fuel gas supply channel 65 connecting the fuel gas supply passage 40 to the fuel gas inlet 48 is formed between the bridges 44, 64.

In each space between the separators 38, a seal member 66 is provided around the fuel gas supply passage 40. As shown in FIGS. 2 and 4, the seal member 66 has a substantially ring shape, and is made of gas sealing, heat resistant, and flexible material. The seal member 66 is a thin membrane seal having a clay membrane made of composite material of clay mineral and organic polymer.

As the seal member 66, for example, Claist (registered trademark) developed by National Institute of Advanced Industrial Science and Technology (Independent Administrative Institution, Japan) may be used. The gas permeability factor of the seal member 66 to the fuel gas and the oxygen-containing gas at room temperature is less than 3.2×10⁻¹¹ cm²s⁻¹cmHg⁻¹. The seal member 66 has a thickness of 1 mm or less, a surface area of 0.1 cm² or more, and a surface pressure applied to the seal member 66 is in a range of 0.1 Mpa to 10 MPa. A predetermined number of the seal members 66 may be stacked depending on the spacing distance between the separators 38. If the surface pressure is 0.1 MPa or less, the desired sealing performance cannot be achieved. In the case where the surface pressure exceeds 10 MPa, though the desired sealing performance can be obtained, the separators 38 and the electrolyte electrode assemblies 36 tend to be deformed or damaged easily due to the excessive load applied to the separators 38 and the electrolyte electrode assemblies 36. Though the thickness of the seal member 66 exceeding 1 mm may be adopted, in the case where the thickness of the seal member 66 is 1 mm or less, the desired gas sealing performance, heat resistant performance, and flexibility can be obtained. In the case where the thickness is less than 10 μm, the desired sealing performance cannot be obtained.

As shown in FIGS. 2 to 4, in the fuel cell 20, an oxygen-containing gas supply channel 68 for supplying the oxygen-containing gas in the stacking direction indicated by the arrow A is formed around the sandwiching sections 46, and exhaust gas channels 70 for discharging the consumed fuel gas and oxygen-containing gas are formed in spaces around the fuel gas supply section 42.

As shown in FIG. 1, end plates 74a, 74b are provided at opposite ends of the fuel cells 20 in the stacking direction. The end plate 74a has a substantially circular disk shape. A hole 76 corresponding to the fuel gas supply passage 40 is formed at the center of the end plate 74a. A plurality of holes 78 are formed corresponding to the exhaust gas channels 70 around the hole 76.

Components between the end plates 74a, 74b are tightened together in the direction indicated by the arrow A by bolts 82 screwed into screw holes 80. The screw holes 80 and the bolts 82 form a tightening section 84. The tightening section 84 applies a tightening load in a range of 10 N to 1000 N to the seal members 66 in the stacking direction of the fuel cell stack 22. In the case where the tightening load is less than 10 N, the desired sealing performance cannot be obtained. In the case where the tightening load exceeds 1000 N, due to the excessive load applied to the separators 38, the separators 38 tend to be deformed easily.

Next, operation of the fuel cell stack 22 including the fuel cells 20 will be described.

As shown in FIG. 1, a fuel gas such as a hydrogen-containing gas is supplied to the hole 76 of the end plate 74a, and an oxygen-containing gas (hereinafter also referred to as the air) is supplied to the oxygen-containing gas supply channel 68 provided around the fuel cell 20.

As shown in FIG. 4, the fuel gas from the fuel gas supply section 42 flows along the fuel gas supply channels 65 in the bridges 44, and flows into the fuel gas channels 52 formed by the projections 54 from the fuel gas inlets 48 of the sandwiching sections 46. The fuel gas inlets 48 are formed at substantially the central positions of the anodes 34 of the electrolyte electrode assemblies 36. Thus, in each of the electrolyte electrode assemblies 36, the fuel gas is supplied from the fuel gas inlet 48 to substantially the central position of the anode 34, and flows outwardly toward the outer circumferential region of the anode 34 along the fuel gas channel 52.

The oxygen-containing gas flows into a space between the outer circumferential edge of the electrolyte electrode assembly 36 and the outer circumferential edge of the sandwiching section 46 in the direction indicated by the arrow B, and flows toward the oxygen-containing gas channel 56. In the oxygen-containing gas channel 56, the oxygen-containing gas flows from the outer circumferential edge (outer circumferential region of the separator 38) to the inner circumferential edge (central region of the separator 38) of the cathode 32 of the electrolyte electrode assembly 36.

Thus, in the electrolyte electrode assembly 36, the fuel gas flows from the center to the circumferential end on the electrode surface of the anode 34, and the oxygen-containing gas flows in one direction indicated by the arrow B on the electrode surface of the cathode 32. At this time, oxide ions flow through the electrolyte 30 toward the anode 34 for generating electricity by electrochemical reactions. The exhaust gas discharged from the outer circumferential region of each of the electrolyte electrode assembly 36 flows through the exhaust gas channel 70 in the stacking direction, and the exhaust gas is discharged from the fuel cell stack 22.

In the first embodiment, as shown in FIG. 4, in the fuel gas supply section 42 of the separator 38, the seal member 66 is provided around the fuel gas supply passage 40.

The seal member 66 has a clay membrane made of composite material of clay mineral and organic polymer. Therefore, the seal member 66 has the high gas sealing performance, and has the high heat resistant performance, insulating performance, and flexibility due to the clay mineral as the chief component of the seal member 66. Therefore, in comparison with the case of adopting a compressive (adhesion by compression) seal member made of mica material, ceramics material or the like, the seal member 66 tightly contacts the sealing surface of the separator 38 with a smaller load in the stacking direction.

For example, in the case of using a gasket made of mica material or the like, in order to achieve the desired sealing performance, a tightening load of (1 to 2)×10⁴N is required. In contrast, in the first embodiment, using the seal member 66, the tightening load applied by the tightening section 84 is reduced significantly to the range of 10 N to 1000 N.

In the structure, no excessive load in the staking direction is applied to the separators 38 and the electrolyte electrode assemblies 36. Accordingly, deformation of the separators 38 and damages of the electrolyte electrode assemblies 36 are prevented suitably.

Moreover, the gas permeability factor of the seal member 66 to the fuel gas and the oxygen-containing gas at room temperature is less than 3.2×10⁻¹¹ cm²s⁻¹ cmHg⁻¹. Therefore, it becomes possible to reliably prevent mixture of gases between the fuel gas and the oxygen-containing gas, and between these gases and the exhaust gas. The desired sealing performance can be maintained over a long period of time.

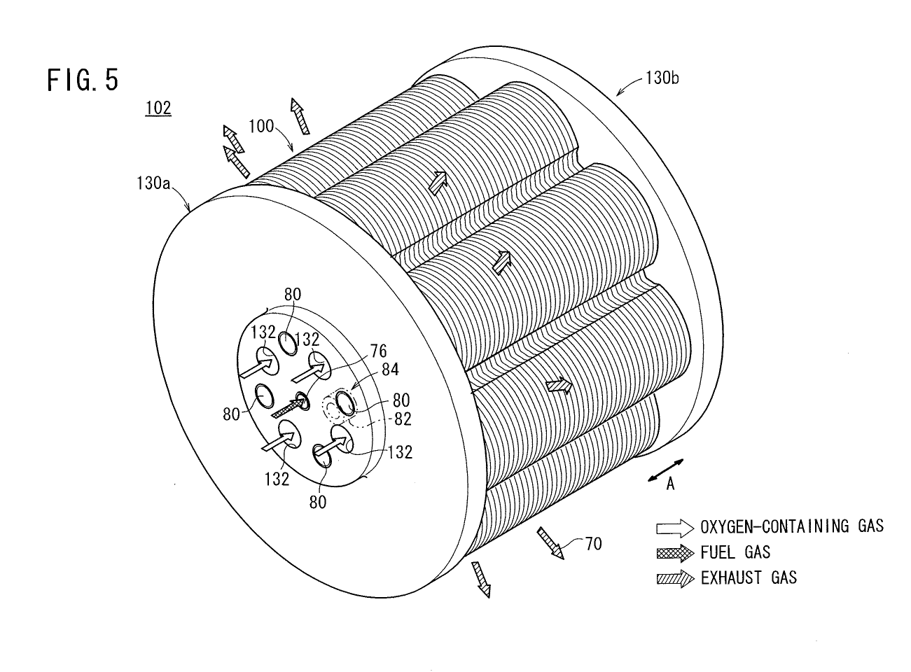

FIG. 5 is a perspective view schematically showing a fuel cell stack 102 formed by stacking a plurality of fuel cells 100 according to a second embodiment of the present invention in a direction indicated by an arrow A. The constituent elements that are identical to those of the fuel cell 20 according to the first embodiment are labeled with the same reference numeral, and description thereof will be omitted. Also in third to ninth embodiments as described later, the constituent elements that are identical to those of the fuel cell 20 according to the first embodiment are labeled with the same reference numeral, and description thereof will be omitted.

In the fuel cell 100, in each space between separators 103, eight electrolyte electrode assemblies 36 are arranged concentrically around a fuel gas supply passage 40 extending through the center of the separators 103.

A fuel gas supply section 104 is formed at the center of the separator 103, and the fuel gas supply passage 40 extends through the fuel gas supply section 104. A plurality of first bridges 106 extend radially outwardly from the fuel gas supply section 104 such that the first bridges 106 are spaced at equal intervals (angles). The fuel gas supply section 104 is integral with sandwiching sections 108 each having a relatively large diameter through the first bridges 106. The centers of the sandwiching sections 108 are equally distanced from the center of the fuel gas supply section 104.

Each of the sandwiching sections 108 has a fuel gas channel 52 on a surface 108a which contacts the anode 34, for supplying a fuel gas along an electrode surface of the anode 34. Further, a fuel gas discharge channel 110 for discharging the fuel gas consumed in the fuel gas channel 52 and a circular arc wall 112 forming a detour path to prevent the fuel gas from flowing straight from the fuel gas inlet 48 to the fuel gas discharge channel 110 are provided on the surface 108a of the sandwiching section 108.

The circular arc wall 112 has a substantially horseshoe shape which is bifurcated from an end of the first bridge 106. The fuel gas inlet 48 is provided on a distal end side inside the circular arc wall 112, and the fuel gas discharge channel 110 is provided on a proximal end side of the circular arc wall 112, near the first bridge 106. On the surface 108a, an annular protrusion 114 and a plurality of projections 54 are provided. The annular protrusion 114 protrudes toward the fuel gas channel 52, and contacts the outer edge of the anode 34, and the projections 54 contact the anode 34.

The protrusion 114 has a substantially ring shape with partial cutout at a position corresponding to the fuel gas discharge channel 110. The projections 54 are made of solid portions formed by, e.g., etching, or hollow portions formed by pressure forming.

The heights of the circular arc wall 112, the protrusion 114, and the projections 54 are determined such that the pressure loss of the fuel gas in the fuel gas channel 52 becomes smaller than the pressure loss of the fuel gas in the fuel gas supply section 104.

Each of the sandwiching sections 108 has a substantially planar surface 108b which contacts the cathode 32. In the fuel gas supply section 104, a plurality of fuel gas orifices 116 are formed around the fuel gas supply passage 40. The diameter of the fuel gas orifice 116 is smaller than the diameter of the fuel gas inlet 48.

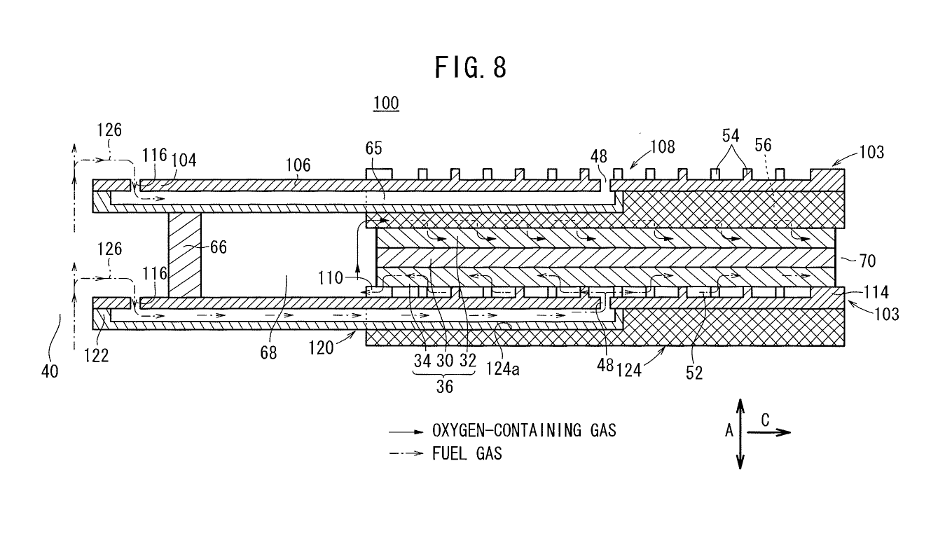

A channel lid member 120 is fixed to a surface of the separator 103 facing the cathode 32, e.g., by brazing, diffusion bonding, or laser welding. The channel lid member 120 has a planar shape. The fuel gas supply passage 40 extends through the fuel gas supply section 62 at the center of the channel lid member 120. Eight second bridges 64 extend radially from the fuel gas supply section 62. Each of the second bridges 64 is fixed to the separator 103 from the first bridge 106 to the surface 108b of the sandwiching section 108 to cover the fuel gas inlet 48 (see FIG. 8).

From the fuel gas supply section 62 to the second bridge 64, a fuel gas supply channel 65 connecting the fuel gas supply passage 40 to the fuel gas inlet 48 is formed. For example, the fuel gas supply channel 65 is formed by, etching. In the fuel gas supply section 62, a ring shaped protrusion 122 is formed around the fuel gas supply passage 40. The protrusion 122 seals the fuel gas supply passage 40 from the fuel gas supply channel 65.

A deformable elastic channel unit such as an electrically conductive mesh member 124 is provided on the surface 108b of the sandwiching section 108. The deformable elastic channel unit such as the electrically conductive mesh member 124 forms an oxygen-containing gas channel 56 for supplying an oxygen-containing gas along an electrode surface of the cathode 32, and tightly contacts the cathode 32.

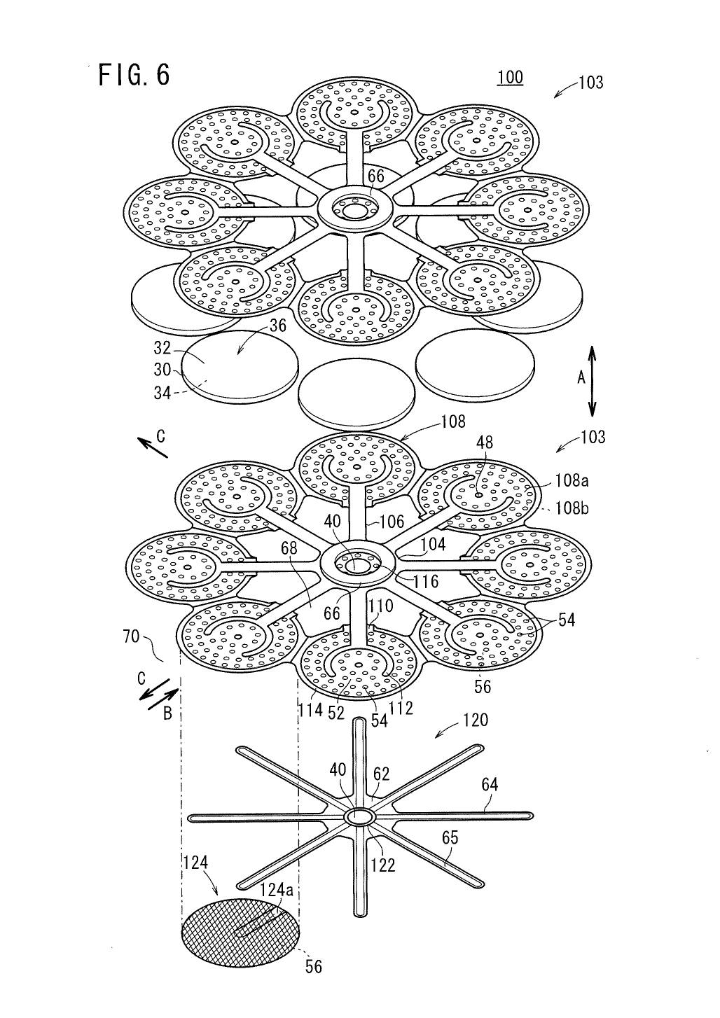

For example, the mesh member 124 is made of a wire rod material such as stainless steel (SUS material), and has a circular disk shape. The thickness of the mesh member 124 is dimensioned such that, when a load in a stacking direction indicated by an arrow A is applied to the mesh member 124, the mesh member 124 is deformed elastically desirably to directly contact the surface 108b of the sandwiching section 108. The mesh member 124 has a cutout 124a for providing a space for the channel lid member 120 (see FIGS. 6 and 8).

As shown in FIG. 8, the oxygen-containing gas channel 56 provided in the mesh member 124 is connected to the oxygen-containing gas supply channel 68 for supplying the oxygen-containing gas from between an inner circumferential edge of the electrolyte electrode assembly 36 and an inner circumferential edge of the sandwiching section 108 in a direction indicated by an arrow C. The oxygen-containing supply channel 68 extends inside the sandwiching sections 108 in the stacking direction indicated by the arrow A, between the respective first bridges 106.

In each space between the separators 103, a seal member 66 surrounding the fuel gas orifices 116 is provided around the fuel gas supply passage 40. This seal member 66 has the same structure as the seal member 66 used in the first embodiment.

An exhaust gas channel 70 is provided outside (around) the sandwiching sections 108 of the fuel cells 100. As shown in FIG. 8, when the fuel cells 100 are stacked together, a branch channel 126 is formed between the separators 103. The branch channel 126 is branched from the fuel gas supply passage 40 to extend along the surface of the separator 103 in the direction indicated by the arrow C. The branch channel 126 and the fuel gas supply channels 65 are connected by the fuel gas orifices 116 formed in the stacking direction indicated by the arrow A.

As shown in FIG. 5, the fuel cell stack 102 includes end plates 130a, 130b each having a substantially circular disk shape at opposite ends of the fuel cells 100 in the stacking direction. At the center of the end plate 130a, a hole 76 corresponding to the fuel gas supply passage 40 is formed, and a plurality of holes 132 are formed around the hole 76, corresponding to the spaces of the oxygen-containing gas supply channel 68.

Operation of the fuel cell stack 102 will be described below.

As shown in FIG. 5, the fuel gas is supplied from the hole 76 of the end plate 130a to the fuel gas supply passage 40, and the air is supplied from the holes 132 to the oxygen-containing gas supply channels 68.

As shown in FIG. 8, the fuel gas flows along the fuel gas supply passage 40 of the fuel cell stack 102 in the stacking direction indicated by the arrow A, and the fuel gas is supplied to the branch channel 126 in each of the fuel cells 100. Thus, the fuel gas flowing in the stacking direction is branched toward the direction along the separator surfaces in the direction indicated by the arrow C. Then, the fuel gas flows through the fuel gas orifices 116, and temporarily flow in the stacking direction. Then, the fuel gas flows along the separator surfaces along the fuel gas supply channel 65 connected to the fuel gas orifices 116.

The fuel gas flows from the fuel gas supply channel 65 to the fuel gas channel 52 through the fuel gas inlet 48 formed in the sandwiching section 108. Thus, the fuel gas is supplied from the fuel gas inlet 48 to the substantially center of the anode 34. The fuel gas flows along the fuel gas channel 52 toward the outer circumferential region of the anode 34.

As shown in FIG. 6, a circular arc wall 112 bifurcated from the end of the first bridge 106 is provided on the surface 108a of the sandwiching section 108 of the separator 103, in the path connecting the fuel gas inlet 48 and the fuel gas discharge channel 110. The circular arc wall 112 contacts the anode 34 of the electrolyte electrode assembly 36.

In the structure, the fuel gas supplied from the fuel gas inlet 48 to the fuel gas channel 52 is blocked by the circular arc wall 112. Thus, the fuel gas does not flow straight from the fuel gas inlet 48 to the fuel gas discharge channel 110. The consumed fuel gas supplied to the fuel gas channel 52 is discharged from the fuel gas discharge channel 110 to the oxygen-containing gas supply channel 68 in the direction indicated by the arrow B. Thus, in the oxygen-containing gas supply channel 68, the fuel gas in the exhaust gas after consumption in the power generation reacts with part of the oxygen-containing gas before consumption in the power generation. As a result, the rest of the oxygen-containing gas before consumption is heated.

The air supplied to the oxygen-containing gas supply channel 68 flows into between the inner circumferential edge of the electrolyte electrode assembly 36 and the inner circumferential edge of the sandwiching section 108 in the direction indicated by the arrow C. The air is supplied to the oxygen-containing gas channel 56 formed in the mesh member 124. In the oxygen-containing gas channel 56, the air flows from the inner circumferential edge of the cathode 32 (center of the separator 103) to the outer circumferential edge of the cathode 32 (outer circumferential edge of the separator 103).

Thus, in the electrolyte electrode assembly 36, the fuel gas flows from the center to the outer circumferential side on the electrode surface of the anode 34, and the oxygen-containing gas (air) flows in one direction indicated by the arrow C on the electrode surface of the cathode 32. At this time, oxide ions flow through the electrolyte 30 toward the anode 34 for generating electricity by electrochemical reactions.

The exhaust gas mainly containing the air after power generation reaction discharged from the outer circumferential region of each of the electrolyte electrode assemblies 36 flows into the exhaust gas channel 70 as the off gas, and the exhaust gas is discharged from the fuel cell stack 102 (see FIG. 5).

In the second embodiment, in each space between the separators 103, the seal member 66 surrounding the fuel gas orifices 116 is provided around the fuel gas supply passage 40. Thus, in the second embodiment, the same advantages as in the case of the first embodiment are obtained.

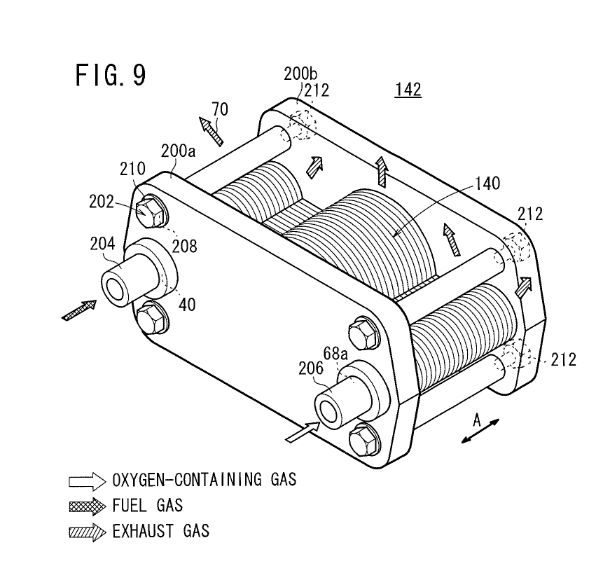

FIG. 9 is a perspective view schematically showing a fuel cell stack 142 formed by stacking a plurality of fuel cells 140 according to a third embodiment in a direction indicated by an arrow A.

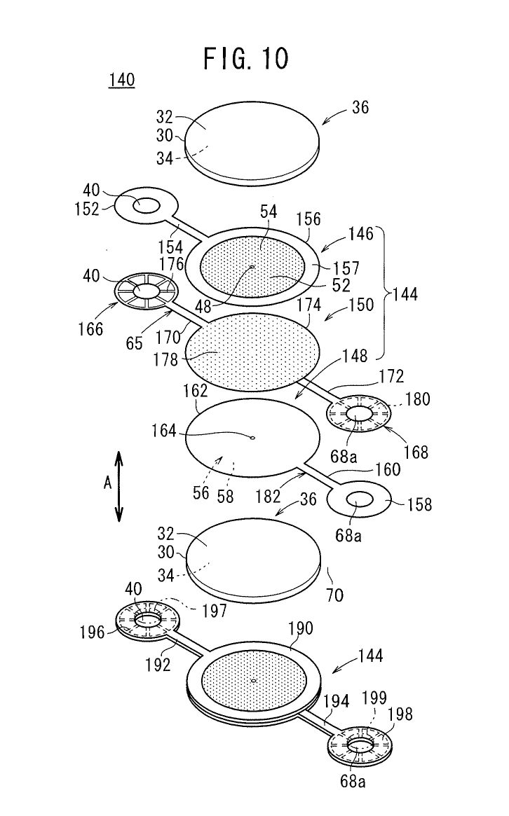

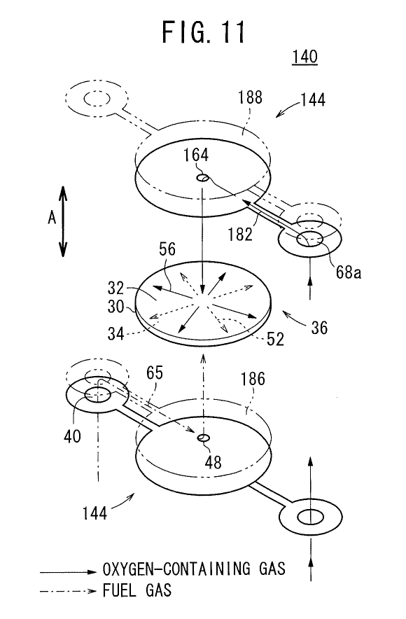

As shown in FIGS. 10 and 11, the fuel cell 140 is formed by sandwiching a single electrolyte electrode assembly 36 between separators 144. The separator 144 includes first and second plates 146, 148 and a third plate 150 interposed between the first and second plates 146, 148. For example, the first to third plates 146, 148, 150 are metal plates of, e.g., stainless alloy. For example, the first and second plates 146, 148 are joined to both surfaces of the third plate 150 by brazing.

As shown in FIG. 10, the first plate 146 includes a first fuel gas supply section 152, and a fuel gas supply passage 40 for supplying a fuel gas in the stacking direction indicated by the arrow A extends through the first fuel gas supply section 152. The first fuel gas supply section 152 is integral with a first sandwiching section 156 having a relatively large diameter through a narrow first bridge 154. The first sandwiching section 156 and the anode 34 of the electrolyte electrode assembly 36 have the same size.

A large number of projections 54 forming a fuel gas channel 52 are provided on a surface of the first sandwiching section 156, which contacts the anode 34, in a central region, adjacent to an outer circumferential region of the first sandwiching section 156. A substantially ring shaped protrusion 157 is provided on the outer circumferential region of the first sandwiching section 156. The projections 54 and the substantially ring shaped protrusion 157 jointly form a current collector.

A fuel gas inlet 48 is provided at the center of the first sandwiching section 156, for supplying the fuel gas toward a substantially central region of the anode 34. The projections 54 may be formed by a plurality of recesses provided in a surface that lies in the same plane as the surface of the substantially ring shaped protrusion 157.

The second plate 148 has a first oxygen-containing gas supply section 158, and an oxygen-containing gas supply passage 68a for supplying an oxygen-containing gas in the stacking direction indicated by the arrow A extends through the first oxygen-containing gas supply section 158. The first oxygen-containing gas supply section 158 is integral with a second sandwiching section 162 having a relatively large diameter through a narrow second bridge 160.

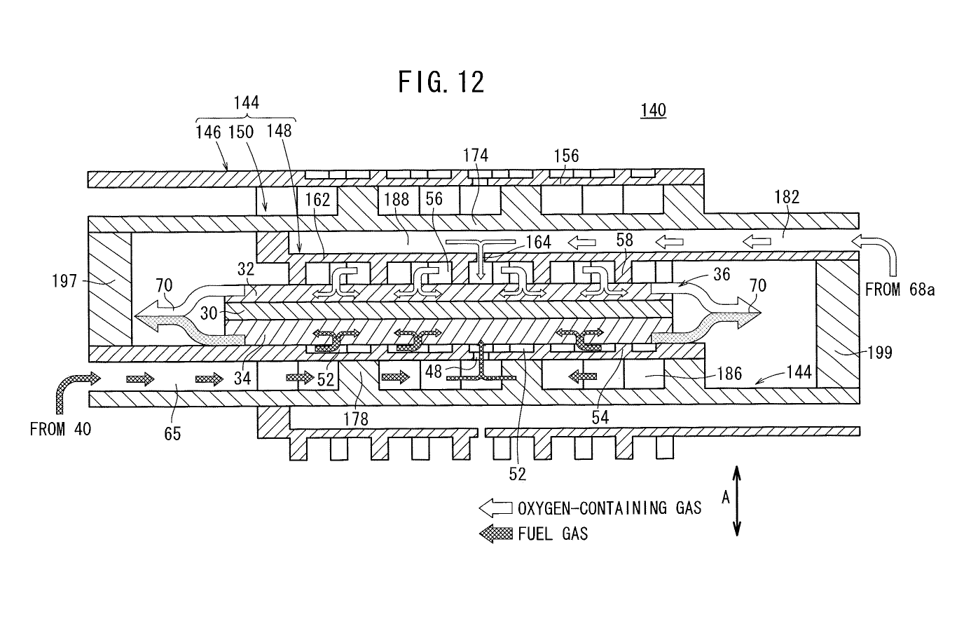

A plurality of projections 58 forming an oxygen-containing gas channel 56 are provided over the entire surface of the second sandwiching section 162, which contacts the cathode 32 of the electrolyte electrode assembly 36 (see FIG. 12). An oxygen-containing gas inlet 164 is provided at the center of the second sandwiching section 162, for supplying the oxygen-containing gas toward a substantially central region of the cathode 32.

The third plate 150 has a second fuel gas supply section 166 and a second oxygen-containing gas supply section 168. The fuel gas supply passage 40 extends through the second fuel gas supply section 166, and the oxygen-containing gas supply passage 68a extends through the second oxygen-containing gas supply section 168. The second fuel gas supply section 166 and the second oxygen-containing gas supply section 168 are integral with a third sandwiching section 174 having a relatively large diameter through narrow third and fourth bridges 170, 172. The diameter of the third sandwiching section 174 is the same as the diameters of the first and second sandwiching sections 156, 162.

A channel 176 including a plurality of slits is formed on the second fuel gas supply section 166. The channel 176 is connected to the fuel gas supply passage 40. The slits of the channel 176 are formed radially on a surface of the third plate 150 facing the first plate 146. A fuel gas supply channel 65 is formed in the surfaces of the third bridge 170, and the third sandwiching section 174. The fuel gas supply passage 40 is connected to the fuel gas supply channel 65 through the channel 176. A plurality of projections 178 are formed in the third sandwiching section 174. The projections 178 form part of the fuel gas supply channel 65.

A channel 180 including a plurality of slits is formed on the second oxygen-containing gas supply section 168. The channel 180 is connected to the oxygen-containing gas supply passage 68a. The slits of the channel 180 are formed radially on a surface of the third plate 150 which contacts the second plate 148. The oxygen-containing gas supply passage 68a is connected to the oxygen-containing gas supply channel 182 of the third sandwiching section 174 through the channel 180. The oxygen-containing gas supply channel 182 is closed by the outer edge of the third sandwiching section 174.

The first plate 146 is joined to one surface of the third plate 150 by brazing to form the fuel gas supply channel 65 connected to the fuel gas supply passage 40 between the first and third plates 146, 150. The fuel gas supply channel 65 is provided between the first and third sandwiching sections 156, 174, over the electrode surface of the anode 34. The first sandwiching section 156 is provided between the fuel gas supply channel 65 and the anode 34. When the fuel gas is supplied to the fuel gas supply channel 65, the first sandwiching section 156 tightly contacts the anode 34 under pressure. That is, the fuel gas supply channel 65 forms a fuel gas pressure chamber 186 (see FIG. 12). An exhaust gas channel 70 for discharging the fuel gas and the oxygen-containing gas used in the power generation reaction is provided around the electrolyte electrode assembly 36.

The second plate 148 is joined to the third plate 150 by brazing to form the oxygen-containing gas supply channel 182 connected to the oxygen-containing gas supply passage 68a between the second and third plates 148, 150. The oxygen-containing gas supply channel 182 is formed between the second and third sandwiching sections 162, 174, over the electrode surface of the cathode 32. The second sandwiching section 162 is provided between the oxygen-containing gas supply channel 182 and the cathode 32. When the oxygen-containing gas is supplied to the oxygen-containing gas supply channel 182, the second sandwiching section 162 tightly contacts the cathode 32 under pressure. That is, the oxygen-containing gas supply channel 182 forms an oxygen-containing gas pressure chamber 188 (see FIG. 12).

In the separator 144, the first sandwiching section 156 of the first plate 146, the second sandwiching section 162 of the second plate 148, and the third sandwiching section 174 of the third plate 150 are joined together to form a sandwiching section 190 having a circular disk shape. The sandwiching section 190 is connected to a bridge 192 formed by joining the first and third bridges 154, 170 together, and a bridge 194 formed by joining the second and fourth bridges 160, 172 together.

The bridge 192 is connected to a fuel gas supply section 196 formed by joining the first fuel gas supply section 152 and the second fuel gas supply section 166. The bridge 194 is connected to the oxygen-containing gas supply section 198 formed by joining the first oxygen-containing gas supply section 158 and the second oxygen-containing gas supply section 168.

As shown in FIGS. 10 and 12, in each space between the separators 144, a seal member 197 is provided around the fuel gas supply passage 40, and a seal member 199 is provided around the oxygen-containing gas supply passage 68a.

The seal members 197, 199 have the same structure as the seal member 66 used in the first embodiment. Each of the seal members 197, 199 has a clay membrane made of composite material of clay mineral and organic polymer. Preferably, a predetermined number of the seal members 197, 199 are stacked together depending on the spacing distance between the separators 144.

As shown in FIG. 9, the fuel cell stack 142 includes a plurality of fuel cells 140 stacked together, and end plates 200a, 200b provided at opposite ends in the stacking direction. The end plate 200a or the end plate 200b is electrically insulated from tightening means 202. The end plate 200a is connected to a first pipe 204 extending to the fuel gas supply passage 40 of the fuel cells 140, and a second pipe 206 extending to the oxygen-containing gas supply passage 68a of the fuel cells 140. At the end plates 200a, 200b, tightening means 202 is provided at positions adjacent to the fuel gas supply passage 40 and the oxygen-containing gas supply passage 68a, and spaced from the electrolyte electrode assemblies 36. The tightening means 202 applies a tightening load to the electrolyte electrode assemblies 36 and the separators 144 stacked in the direction indicated by the arrow A.

The tightening means 202 includes bolt holes 208 formed in the end plate 200a, 200b, at positions on both sides of the fuel gas supply passage 40 and on both sides of the oxygen-containing gas supply passage 68a. Tightening bolts 210 are inserted into the bolt holes 208, and tip ends of the tightening bolts 210 are screwed into nuts 212 to tighten components of the fuel cell stack 142 together. A stacking load in a range of 10 N to 1000 N is applied to the seal members 197, 199 in the stacking direction.

Operation of the fuel cell stack 142 will be described below.

As shown in FIG. 9, the fuel gas is supplied from the first pipe 204 connected to the end plate 200a and the oxygen-containing gas is supplied from the second pipe 206 connected to the end plate 200a. The fuel gas flows into the fuel gas supply passage 40, and the oxygen-containing gas flows into the oxygen-containing gas supply passage 68a.

As shown in FIG. 12, the fuel gas supplied to the fuel gas supply passage 40 flows in the stacking direction indicated by the arrow A, and the fuel gas is supplied to the fuel gas supply channel 65 in the separator 144 of each fuel cell 140. The fuel gas flows along the fuel gas supply channel 65 into the fuel gas pressure chamber 186 formed between the first and third sandwiching sections 156, 174. The fuel gas moves between the projections 178, and flows into the fuel gas inlet 48 formed at the center of the first sandwiching section 156.

The fuel gas inlet 48 is provided at a position corresponding to the central position of the anode 34 in each of the electrolyte electrode assemblies 36. Therefore, the fuel gas from the fuel gas inlet 48 is supplied to the fuel gas channel 52, and flows from the central region of the anode 34 toward the outer circumferential region of the anode 34.

The oxygen-containing gas supplied to the oxygen-containing gas supply passage 68a flows along the oxygen-containing gas supply channel 182 in the separator 144, and the oxygen-containing gas is supplied into the oxygen-containing gas pressure chamber 188 formed between the second and third sandwiching sections 162, 174. Then, the oxygen-containing gas flows into the oxygen-containing gas inlet 164 formed at the center of the second sandwiching section 162.

The oxygen-containing gas inlet 164 is provided at a position corresponding to the central position of the cathode 32 in each of the electrolyte electrode assemblies 36. Therefore, the oxygen-containing gas from the oxygen-containing gas inlet 164 is supplied to the oxygen-containing gas channel 56, and flows from the central region of the cathode 32 toward the outer circumferential region of the cathode 32.

Thus, in each of the electrolyte electrode assemblies 36, the fuel gas is supplied from the central region of the anode 34 to the outer circumferential region of the anode 34, and the oxygen-containing gas is supplied from the central region of the cathode 32 to the outer circumferential region of the cathode 32 for generating electricity. The fuel gas and the oxygen-containing gas used in the power generation are discharged as the exhaust gas from the outer circumferential region of the sandwiching section 190.

In the third embodiment, as shown in FIG. 12, in each space between the separators 144, the seal member 197 is provided around the fuel gas supply passage 40, and the seal member 199 is provided around the oxygen-containing gas supply passage 68a. Thus, in the third embodiment, the same advantages as in the cases of the first and second embodiments are obtained.

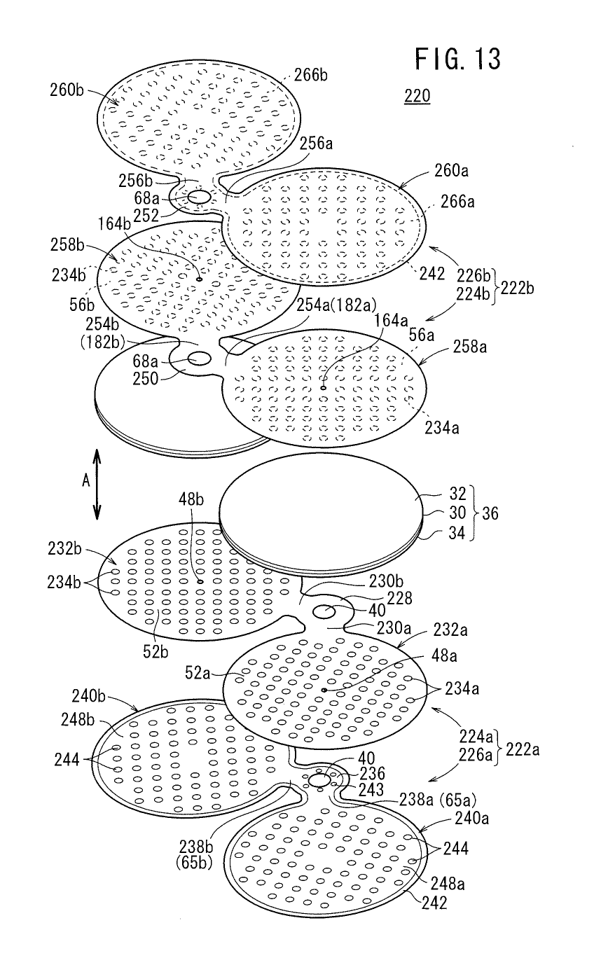

FIG. 13 is an exploded perspective view showing a fuel cell 220 according to a fourth embodiment of the present invention.

The fuel cell 220 is formed by sandwiching a plurality of, e.g., two electrolyte electrode assemblies 36 between a first separator 222a and a second separator 222b. The first separator 222a and the second separator 222b comprise separator bodies having the same shape, and oriented 180° opposite to each other.

The first separator 222a includes a first plate 224a and a second plate 226a. The first and second plates 224a, 226a are metal plates of, e.g., stainless alloy. For example, the first plate 224a and the second plate 226a are joined to each other by diffusion bonding, laser welding, or brazing.

The first plate 224a has a substantially planar shape, and includes a first fuel gas supply section 228. A fuel gas supply passage 40 extends through the first fuel gas supply section 228 for supplying the fuel gas in the stacking direction indicated by the arrow A. The first fuel gas supply section 228 is integral with first sandwiching sections 232a, 232b through first bridges 230a, 230b extending outwardly from the first fuel gas supply section 228.

The first sandwiching sections 232a, 232b and the electrolyte electrode assemblies 36 have the same size. Projections 234a, 234b are formed on surfaces of the first sandwiching sections 232a, 232b facing the anodes 34. The projections 234a, 234b form fuel gas channels 52a, 52b for supplying the fuel gas along the electrode surfaces of the anodes 34, and have a current collection function. Fuel gas inlets 48a, 48b for supplying the fuel gas to substantially central regions of the anodes 34 are formed at substantially central positions of the first sandwiching sections 232a, 232b.

The second plate 226a has a second fuel gas supply section 236, and the fuel gas supply passage 40 extends through the second fuel gas supply section 236. The second fuel gas supply section 236 is integral with second sandwiching sections 240a, 240b through two second bridges 238a, 238b extending outwardly from the second fuel gas supply section 236. An annular ridge 242 is provided in an outer circumferential portion of the second plate 226a. The annular ridge 242 protrudes toward the first plate 224a, and is joined to the first plate 224a.

A plurality of projections 243 are formed on surfaces of the second fuel gas supply section 236, the second bridges 238a, 238b, and the second sandwiching sections 240a, 240b facing the first plate 224a. The projections 243 contact the first plate 224a to prevent collapsing due to a load in the stacking direction.

Fuel gas supply channels 65a, 65b connected to the fuel gas supply passage 40 are formed between the first and second bridges 230a, 238a, and between the first and second bridges 230b, 238b. The fuel gas supply channel 65a, 65b are connected to the fuel gas inlets 48a, 48b through fuel gas filling chambers 248a, 248b formed between the first sandwiching section 232a and the second sandwiching section 240a, and between the first sandwiching section 232b and the second sandwiching section 240b.

The first separator 222a and the second separator 222b have the same shape. The second separator 222b includes a first plate 224b and a second plate 226b corresponding to the first plate 224a and the second plate 226a. The first plate 224b and the second plate 226b have first and second oxygen-containing gas supply sections 250, 252. An oxygen-containing gas supply passage 68a, which supplies the oxygen-containing gas in the stacking direction, extends through the first and second oxygen-containing gas supply sections 250, 252.

In the first plate 224b and the second plate 226b, the first and second oxygen-containing gas supply sections 250, 252 are integral with first sandwiching sections 258a, 258b, and second sandwiching sections 260a, 260b through two first bridges 254a, 254b and two second bridges 256a, 256b extending outwardly from the first and second oxygen-containing gas supply sections 250, 252, respectively.

A plurality of projections 234a, 234b are provided on surfaces of the first sandwiching sections 258a, 258b which contact the cathodes 32. The projections 234a, 234b form oxygen-containing gas channels 56a, 56b for supplying the oxygen-containing gas along electrode surfaces of the cathodes 32. Oxygen-containing gas inlets 164a, 164b for supplying the oxygen-containing gas to substantially central regions of the cathodes 32 are formed at substantially central positions of the first sandwiching sections 258a, 258b.

The second plate 226b is joined to the first plate 224b to form oxygen-containing gas supply channels 182a, 182b between the first bridges 254a, 254b, and the second bridges 256a, 256b. The oxygen-containing gas supply channels 182a, 182b are connected to the oxygen-containing gas supply passage 68a.

Oxygen-containing gas filling chambers 266a, 266b are formed in the second sandwiching sections 260a, 260b. The oxygen-containing gas supply passage 68a is connected to the oxygen-containing gas filling chambers 266a, 266b through the oxygen-containing gas supply channels 182a, 182b.

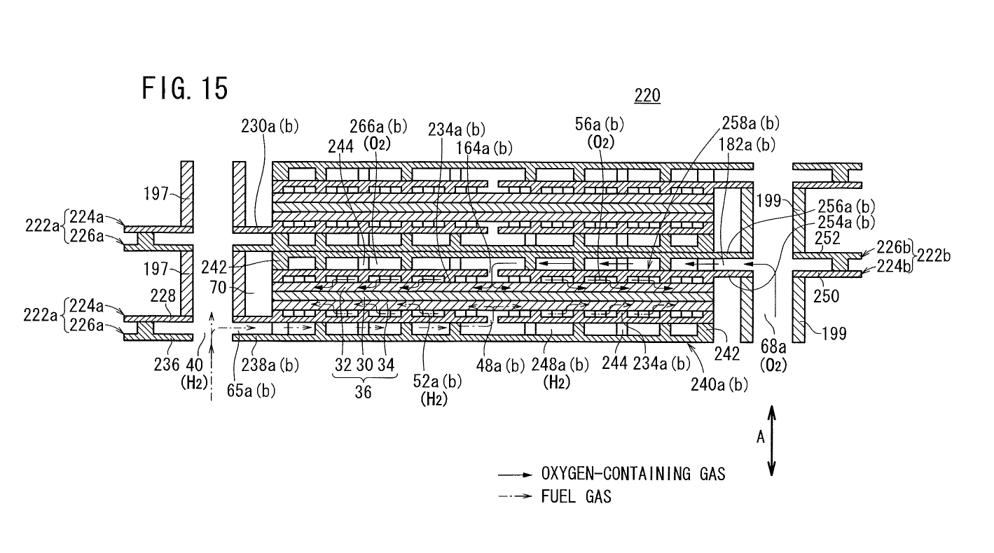

As shown in FIG. 15, in each space between the fuel cells 220, a seal member 197 is provided around the fuel gas supply passage 40, and a seal member 199 is provided around the oxygen-containing gas supply passage 68a.

Operation of the fuel cell 220 will be described below.

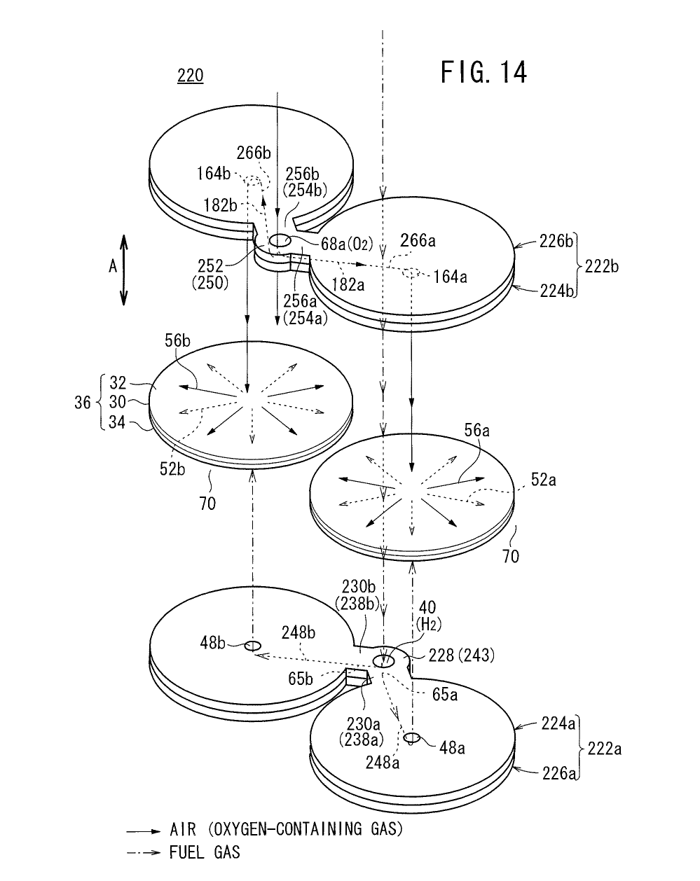

The fuel gas moves in the stacking direction indicated by the arrow A, and flows into the fuel gas supply channels 65a, 65b formed in the first separator 222a of each fuel cell 220 (see FIGS. 14 and 15).

The fuel gas flows along the fuel gas supply channels 65a, 65b, and the fuel gas is temporarily filled in the fuel gas filling chambers 248a, 248b. The fuel gas flows through the fuel gas inlets 48a, 48b toward the fuel gas channels 52a, 52b. The fuel gas inlets 48a, 48b are formed at substantially the central positions of the anodes 34 of the electrolyte electrode assemblies 36. Thus, the fuel gas flows from substantially central regions to outer circumferential regions of the anodes 34 along the fuel gas channels 52a, 52b.

The air is supplied to the oxygen-containing gas supply passage 68a of each fuel cell 220. As shown in FIGS. 14 and 15, the air supplied to the oxygen-containing gas supply passage 68a flows along the oxygen-containing gas supply channels 182a, 182b, and the oxygen-containing gas is temporarily filled in the oxygen-containing gas filling chambers 266a, 266b. Thereafter, the oxygen-containing gas flows through the oxygen-containing gas inlets 164a, 164b into the oxygen-containing gas channels 56a, 56b.

The oxygen-containing gas inlets 164a, 164b are formed at substantially the central positions of the cathodes 32 of the electrolyte electrode assemblies 36. Thus, the oxygen-containing gas flows from substantially central regions to outer circumferential regions of the cathodes 32 along the oxygen-containing gas channels 56a, 56b.

The consumed fuel gas which has passed through the fuel gas channels 52a, 52b and the consumed air which has passed through the oxygen-containing gas channels 56a, 56b are discharged from the outer circumferential regions of the electrolyte electrode assemblies 36 to the exhaust gas channel 70, and mixed together in the exhaust gas channel 70. The mixed gas is discharged as an exhaust gas having a relatively high temperature.

In the fourth embodiment, as shown in FIG. 15, in each space between the fuel cells 220, the seal member 197 is provided around the fuel gas supply passage 40, and the seal member 199 is provided around the oxygen-containing gas supply passage 68a. Thus, in the fourth embodiment, the same advantages as in the case of the third embodiment are obtained.

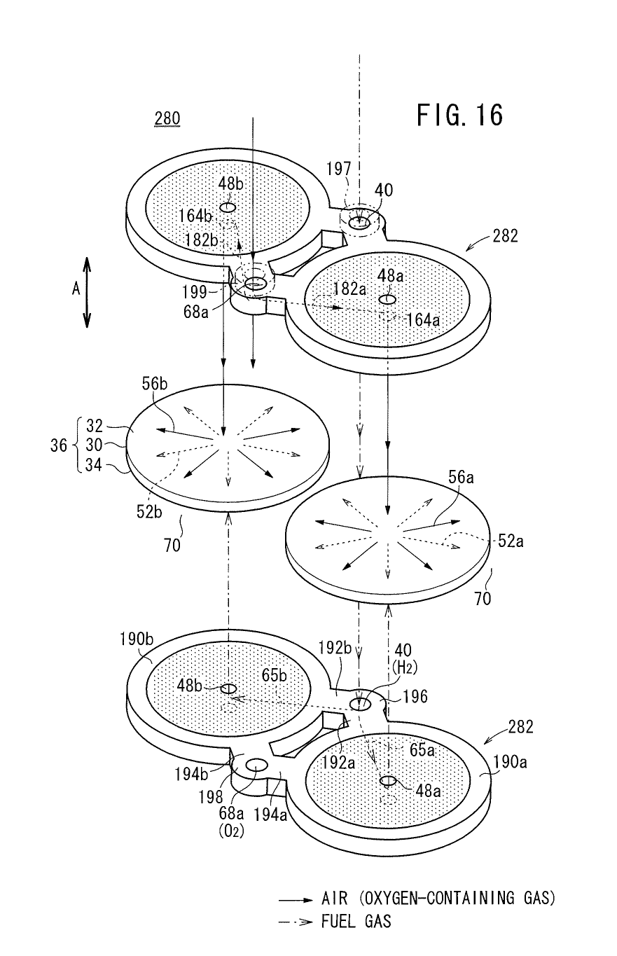

FIG. 16 is an exploded perspective view showing a fuel cell 280 according to a fifth embodiment of the present invention.

The fuel cell 280 includes separators 282 sandwiching two electrolyte electrode assemblies 36. As in the case of the separator 144 used in the third embodiment, the separator 282 is made up of three plates (not shown). Each of the separator 282 includes a first sandwiching section 190a and a second sandwiching section 190b for sandwiching the electrolyte electrode assemblies 36. Each of the first sandwiching section 190a and the second sandwiching section 190b has a circular disk shape.

The first sandwiching section 190a and the second sandwiching section 190b are connected to a fuel gas supply section 196 through bridges 192a, 192b, and connected to an oxygen-containing gas supply section 198 through bridges 194a, 194b. Fuel gas supply channels 65a, 65b are formed in the bridges 192a, 192b, and oxygen-containing gas supply channels 182a, 182b are formed in the bridges 194a, 194b.

A fuel gas channel 52a and an oxygen-containing gas channel 56a are formed between the first sandwiching sections 190a and the electrolyte electrode assembly 36, and a fuel gas channel 52b and an oxygen-containing gas channel 56b are formed between the second sandwiching sections 190b and the electrolyte electrode assembly 36.

In each space between the separators 282, a seal member 197 is provided in the fuel gas supply section 196, around the fuel gas supply passage 40, and a seal member 199 is provided in the oxygen-containing gas supply section 198, around the oxygen-containing gas supply passage 68a.

In the fifth embodiment, the same advantages as in the cases of the embodiments as described above are obtained.

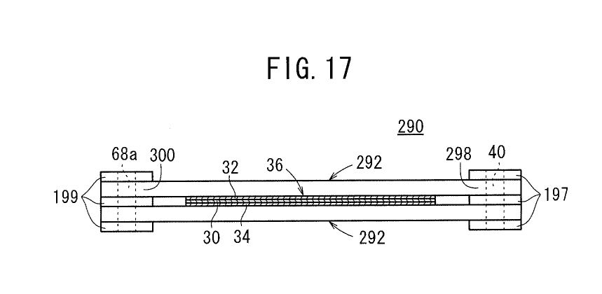

FIG. 17 is a cross sectional view showing a fuel cell 290 according to a sixth embodiment of the present invention.

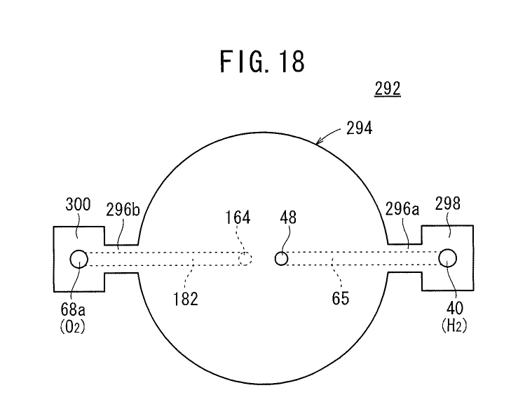

The fuel cell 290 includes separators 292 sandwiching a single electrolyte electrode assembly 36. As shown in FIG. 18, a sandwiching section 294 is provided at the center of the separator 292, and a fuel gas supply section 298 and an oxygen-containing gas supply section 300 are formed integrally with diagonal positions of the sandwiching section 294 through bridges 296a, 296b, respectively.

A fuel gas supply passage 40 extending through the fuel gas supply section 298 is connected to a fuel gas inlet 48 formed at substantially the central position of the sandwiching section 294 through a fuel gas supply channel 65. An oxygen-containing gas supply passage 68a extending through the oxygen-containing gas supply section 300 is connected to an oxygen-containing gas inlet 164 formed at substantially the central position of the sandwiching section 294 through an oxygen-containing gas supply channel 182.

As shown in FIG. 17, in each space between the separators 292, a seal member 197 is provided around the fuel gas supply passage 40, and a seal member 199 is provided around the oxygen-containing gas supply passage 68a.

In the sixth embodiment, the same advantages as in the cases of the embodiments described above are obtained.

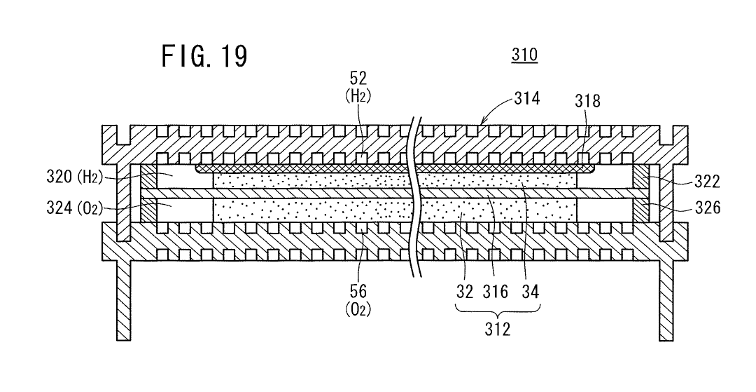

FIG. 19 is a cross sectional view showing a fuel cell 310 according to a seventh embodiment of the present invention.

The fuel cell 310 includes separators 314 sandwiching a single electrolyte electrode assembly 312. The electrolyte electrode assembly 312 includes a cathode 32, and an anode 34, and an electrolyte layer 316 interposed between the cathode 32 and the anode 34. The surface area of the electrolyte layer 316 is larger than the surface areas of the cathode 32 and the anode 34.

The separator 314 has a fuel gas channel 52 on its surface facing the anode 34, and an oxygen-containing gas channel 56 on its surface facing the cathode 32. A metal mesh 318 is interposed between the separator 314 and the anode 34.

In each space between the separator 314 and the electrolyte layer 316, a seal member 322 is provided around the fuel gas supply section 320, and a seal member 326 is provided around the oxygen-containing gas supply section 324. As in the case of the seal member 66 described above, each of the seal members 322, 326 has a clay membrane made of composite material of clay mineral and organic polymer. A predetermined number of the seal members 322 and a predetermined number of the seal members 326 are stacked.

Thus, in the seventh embodiment, the same advantages as in the cases of the first to sixth embodiments are obtained.

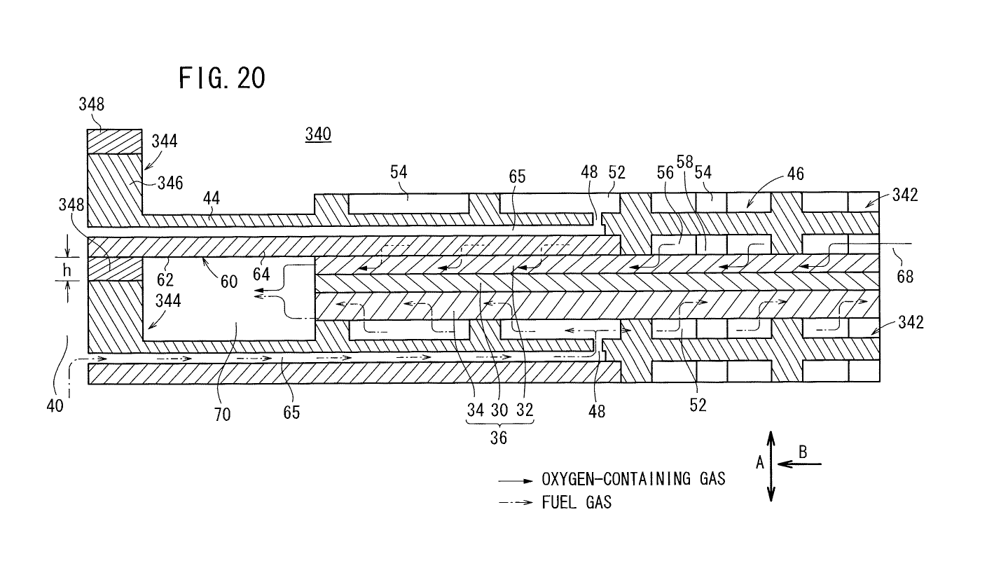

FIG. 20 is a cross sectional view showing a fuel cell 340 according to an eighth embodiment of the present invention.

The fuel cell 340 has substantially the same structure as the fuel cell 20 according to the first embodiment. The structure of the fuel cell 340 is also applicable to the second to seventh embodiments. Further, the structure of a ninth embodiment described later is also applicable to the second to seventh embodiments.

The fuel cell 340 includes separators 342. The separator 342 has a fuel gas supply section 344, and a fuel gas supply passage 40 extends through the fuel gas supply section 344. A projection 346 protruding in a stacking direction is provided in the fuel gas supply section 344, around the fuel gas supply passage 40. A seal member 348 is provided between the projection 346 and the adjacent separator 342.

The seal member 348 has a thickness h of 1 mm or less, a surface area of 0.1 cm² or more, and a surface pressure in a range of 0.1 Mpa to 10 MPa is applied to the seal member 348. One or more seal members 348 are stacked between a top of the projection 346 of one separator 342 and another separator 342.

As described above, in the eighth embodiment, further reduction in the thickness of the seal member 348 is achieved. Therefore, the surface area of the seal member 348 exposed to the fuel gas is reduced significantly, and improvement in the durability is achieved.

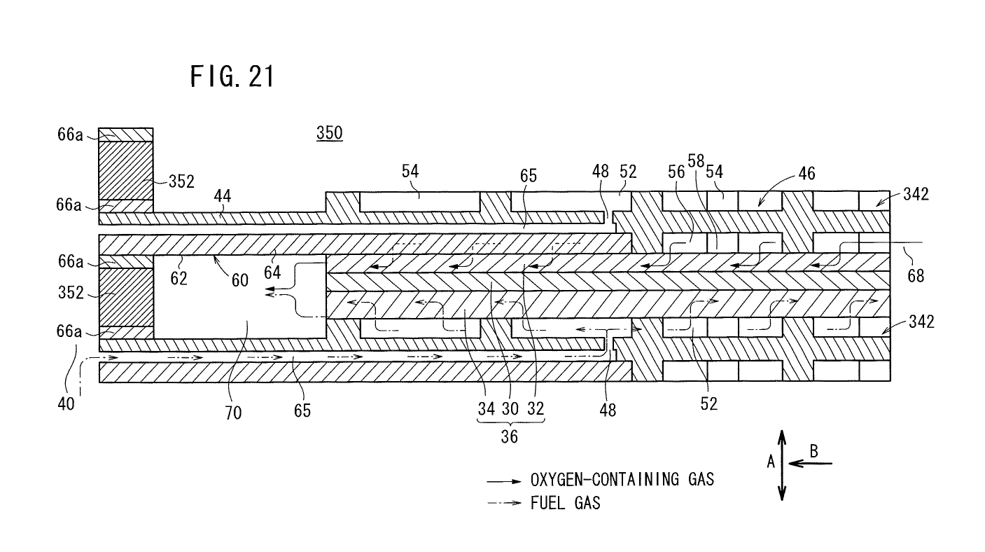

FIG. 21 is a cross sectional view showing a fuel cell 350 according to the ninth embodiment of the present invention.

The fuel cell 350 includes separators 342, and a ring member 352 is provided as a spacer in a fuel gas supply section 42 of the separator 342. Thin seal members 66a are provided on both sides of the ring member 352. Therefore, further reduction in the thickness of the seal member 66a is achieved, and the same advantages as in the case of the eighth embodiment are obtained.

1. A fuel cell formed by stacking an electrolyte electrode assembly between separators, the electrolyte electrode assembly including an anode, a cathode, and a solid oxide electrolyte interposed between the anode and the cathode,
the separators having a fuel gas supply section for supplying a fuel gas to the anode or an oxygen-containing gas supply section for supplying an oxygen-containing gas to the cathode,
wherein a seal member for preventing leakage of the fuel gas or the oxygen-containing gas is provided on at least the fuel gas supply section or the oxygen-containing gas supply section;
the seal member has a clay membrane made of a composite material of clay mineral and organic polymer for adhesion to the separators, the clay membrane having gas seal properties; and
the seal member has a thickness of 1 mm or less and 10 μm or more.

2. A fuel cell according to claim 1, wherein the gas permeability factor of the seal member to the fuel gas and the oxygen-containing gas at room temperature is less than 3.2×10⁻¹¹ cm²S⁻¹cmHg⁻¹.

3. A fuel cell according to claim 1, wherein the seal member has a surface area of 0.1 cm² or more, and a surface pressure applied to the seal member is in a range of 0.1 Mpa to 10 MPa.

4. A fuel cell according to claim 1, further comprising a tightening section for applying a tightening load in a range of 10 N to 1000 N to the seal member in a stacking direction of the fuel cell.

5. A fuel cell according to claim 2, wherein the seal member has a surface area of 0.1 cm² or more, and a surface pressure applied to the seal member is in a range of 0.1 Mpa to 10 MPa.
